(19) United States
(12) Patent Application Publication
(10) Pub. No.: US 2021/0220684 A1
(43) Pub. Date: Jul. 22, 2021

(54) SUBMERSIBLE WATER LIFTING ASSEMBLY AND AUTOMATIC FIRE FIGHTING SYSTEM FOR UNMANNED PLATFORMS HAVING SAID SYSTEM

(71) Applicants: Ukalal Devjibhai Parmar, Ahmedabad (IN); Dhruvil Umeshbhai Sagar, Ahmedabad (IN)

(72) Inventors: Ukalal Devjibhai Parmar, Ahmedabad (IN); Dhruvil Umeshbhai Sagar, Ahmedabad (IN)

(21) Appl. No.: 17/055,476

(22) PCT Filed: May 13, 2019
(86) PCT No.: PCT/IN2019/050381

§ 371 Date: Nov. 13, 2020

(30) Foreign Application Priority Data
May 17, 2018 (IN) 201821018583

(51) Int. Cl. A62C 35/60; A62C 3/06; A62C 35/68; E21B 35/00; F04D 15/00; F04D 29/42; F04D 29/44; F04D 29/22; F04D 29/046; F04D 29/044; F04D 29/70; F03B 13/00

(52) U.S. Cl. CPC A62C 35/60; A62C 3/06; A62C 35/68; E21B 35/00; F04D 15/0005; F03B 13/00; F04D 29/445; F04D 29/22; F04D 29/046; F04D 29/044; F04D 29/708; F04D 29/426

(57) ABSTRACT

The technology relates to a submersible water lifting assembly and automatic fire fighting system for unmanned platforms having said system (1) that is efficient yet simple to install, energy saving, noise free and economical. The present submersible water lifting assembly can comprise a High Pressure Recovery Turbine Pump (7/7A) that utilizes under water arrangements of an unmanned platform and enables the fire-fighting system to efficiently lift water from the sea water; using the force of an existing water injection system; eliminating the requirement of diesel engine driven pump, for the lifting the water. It avoids fire risk on the safety system itself, even under the conditions of a large fire, unlike that of the prior art.

### FIELD OF THE INVENTION

The present invention relates to a submersible water lifting assembly and automatic fire fighting system for unmanned platforms having said system. Particularly, the present invention relates to a submersible water lifting system for automatic fire fighting at unmanned platform having said system, that is efficient yet simple to install, energy saving, noise free, and economical.

### BACKGROUND OF INVENTION AND THE PRIOR ART

Mineral oil and Natural gas are most valuable products in terms of economy. There are two main sectors in this Industry:
1) Upstream sector: for Exploration and Exploitation of Oil and Gas.
2) Down Stream sector: for Refining, Storing, Transporting and distributing among consumers.

In upstream sector, there are two main departments: Drilling Department and Production Department. The function of drilling department is, to explore the area on land (onshore) and offshore (in sea) with higher possibility of Oil/Gas existence and then drill wells in those area for exploitation of these products. After drilling wells, the task is taken over by the production department; whereby the content is extracted to obtain fluid containing oil, gas, water and earth materials like dirt/sand etc. These components are then separated to make these products (oil and gas) compatible for further processing (say refining).

Now this separation process of oil, gas and water needs equipment and vessels like, separators, Knock Out Drums (KODs), storage vessels, power generators, pumps and motor, pipe lines etc. Thus, a complete plant is required in place for carrying out separation process; which requires large space. There are onshore plants (on land) as well as offshore (in sea) plants for the mentioned purpose.

The offshore plants have marine structures known as platforms with various deck levels (say it, floors of building) to accommodate living quarters for human being as well as process plant for oil and gas separation. The Marine Structure, having living quarters, are called manned Platforms (or process complex) and the marine structure without living quarters for human being are called unmanned platforms. (Unmanned platform is also known as Well Head Platform)

It is pertinent to note that the oil rich area, under earth surface (called Reservoir) is spread over large area in square kilometers. So, numbers of wells are required to be drilled over this area and offshore platforms are built on groups of such wells to maximize production of oil. Amongst said offshore platforms, one of the platforms is usually a processing platform; where the contents from all wells can be collected and processed under the supervision of men. Rest of the platforms work on automated mode and generally do not require continuous supervision and hence remain unmanned. All unmanned platforms are inter connected with said manned platform through subsea pipe lines (generally at Sea bed level), like, well fluid lines, water injection lines, gas injection lines, etc. Wherein, said Water injection line is high pressure water line to inject water into wells for recovery of oil. Said unmanned platforms are occasionally visited by men for operational/maintenance jobs. Generally, it is remotely operated from manned platform.

Water injection systems are used for oil recovery extraction from oil reservoir (underground in the earth) by injecting high pressure water in some wells and extracting oil from other wells. This is called secondary oil recovery. The wells, in which, pressurized water is injected, are called water injection wells, whereas the wells, from which, oil extracted, are called Oil producing wells. Wells at sea bed; wherein pressurized water is injected in to the water injection wells to pressurize oil in the reservoir and to recover oil from the nearby oil wells, drilled by the drilling department of the oil and gas industry. The water has such high pressure that it limits the application to the above mentioned purpose and it is risky to use for any other purposes at such pressure. The pressure is so high that it can damage material and men if it use directly for fire fighting purpose; and is manually difficult to control or at times it is uncontrollable in given situation and with given resources

Since Oil and natural gas are highly flammable, there is a high risk of fire associated with such platforms; which results in huge destruction and losses of assets and manpower. So the fire fighting system has vital role in productivity by safeguarding assets and human lives. Existing fire-fighting systems generally uses one or more of the below technologies depending upon complexity of plant, means, nature of fire, types of area like open area or enclosed area etc:
Dry Chemical Powder (DCP) system,
Halon/FM-200 system,
Foam Water Hose Reel (FWHR),
Fire Water Firefighting (FWFF) System,
CO2 stuffing System, and fire extinguishers.

But there are places in offshore platforms where compatible firefighting systems are either not available or if available then it is difficult to operate in automatic mode. Also, all existing systems are not compatible for unmanned platform at offshore, either by water flow quantity or by timely action to extinguish fire.

Moreover, while certain systems require maintenance at regular intervals; during which the platform is rendered disconnected with the firefighting system. Accidents leading to fire at this point may run the risk of complete destruction and human loss. Certain systems tend to chock and fail to operate when actually required; leading to the failure to serve the purpose. Additionally, manual operation or starting of firefighting system operation is not adequate at unmanned offshore platforms; as men do not reside there. Certain systems also fail to operate in open area while others fail to serve the purpose at closed areas. Their reliability for total, efficient and all types of fire extinction at Oil and Gas platforms is questionable.

Certain incidences have been recorded, when such platforms caught fire; due to gas leakage and the installed fire-fighting system did not work or support at that moment; leading to huge losses and emergency; calling for requirement of external help. At said platforms, which are far away from land; and between water on all the sides limited external help could be provided; when such incidences take place. With the available technology for this purpose; said external help includes firefighting ships that uses high power diesel based pumps to lift water and pours on the fire caught areas or Army/Navy helicopters for transfer of manpower and strategic planning. Thus, existing system were proven insufficient or inefficient to safeguard the offshore platforms when fire took place. This was specifically worst when the offshore platforms were unmanned platforms.

Major letdowns were due to failure of water-lifting system to start lifting water for fire-fighting system to work; wherein said water lifting systems were heavy and bulky fire engine and pump. This lifting system needs regular maintenance which is difficult at unmanned platform as man is not residing there. Alternative water lifting systems face problems of chocking with marine growth and failure of operations when in need.

Thus, there is an unmet need to provide a water lifting system for automatic firefighting, in oil and gas industry to be used at said platforms; especially such systems that are feasible and useful at offshore platforms. Particularly, there is a need to provide such system that is efficient yet simple to install and economical.

Disadvantages of the Prior Arts:

Existing water lifting system for automatic fire fighting, suffer from at least one of the following disadvantages:
1. External aids such as ships and helicopter; which is expensive, at times not feasible and leads to huge losses by the time the external help is called and it reaches the platform;
2. The heavy diesel engine based pumps need regular maintenance which is difficult at unmanned platform as man is not residing there. This result in failure of working of them; when actually required.
3. Existing water lifting systems face problems of chocking with marine growth and failure of operations when in need.
4. The existing water lifting system for firefighting, require complex, multi and costly installations; yet fails to ensure safety and efficiency.
5. Said bulky installations and its connection with the platform make up a complex system; difficult and risky to operate.
6. Said bulky installations require large space for installation; which is a concern on offshore platforms.
7. They require external energy sources to initiate the operation. This adds to cost and complexity of installation and operation.
8. The existing systems fail to start in automatic mode for extinguishing fire at offshore platforms. Common problems include:
   a. Fire water pumps needs start up air/gas volume bottle (vessel). Insufficient pressure in this vessel, cause starts up failure during Fire/Emergency.
   b. If start up vessel to be filled with air, then air compressor is needed, which is difficult task at unmanned platform as; sufficient electric power is not available at unmanned platform.
   c. If start up vessel is to be filled with gas, which is abundantly available in the platform, then exhausted start up gas is added into fire place which increases risk of fire hazard during that particular incident. Especially, there is not much use of manual start up for firefighting system at unmanned platform, as men are not residing there. Thus, safety of unmanned platforms is at risk; with existing fire-fighting systems.
9. The maintenance of fire water pump in prior art, is very tedious job; which require lifting (pulling out) of 40 meter length column, (same length of shaft and numbers of impellers) from subsea level to deck level, is time consuming and difficult process. It needs sometimes more than one week; during that period platform runs in unsafe condition.
10. Diesel storage vessel is required for operation of fire water pump; wherein vessel itself has risks of catching fire. Storage Vessel also adds on to the problems of space on said platform.
11. Moreover, diesel storage tank of the prior art systems, mounted on the body of engine, is also under fire risk.
12. Unmanned platform has limited space to install fire water lifting system that limit the selection of safe area for installation, hence, in spite of fire protection wall; there are chances of fire hazards on the running fire water pump during fire incident.
13. The existing systems being unreliable; lead to higher premium of insurance of the platform.
14. Marine growth at suction strainer, restrict flow rate of water, hence insufficient water flow during fire incident is big problem.
15. If battery required for startup of fire engine of fire water pump; failure of battery charging is day to day problem at unmanned platform. Battery charging at unmanned platform is done by solar panel installed at periphery of helideck. Sometimes high air blow of helicopter's propeller, damage the solar panel, and at other times, high wind storm also damage this solar panel. Above all every day dropping of sea birds excretion, block the solar sensitivity which stop power generation in solar panel and hence battery charging is questionable. And other option is power generation by Diesel Generator which is done only when, man visits this unmanned platform.
16. The systems that uses water injection lines as a part of firefighting systems also suffer from throttling effect and problems associated with it; which includes:
   a. Due to high throttling effect, ice cooling takes place around control valve and line chocking by ice formation may occur inside the flow line which reduces flow rate of water.
   b. Due to high throttling, control valve sheet in control valve, erodes fast and causes valve passing problem. And passing of valve, during closed position of valve, is serious problem at offshore; because isolation valve must kept closed during normal period to avoid pressure build up in downstream of flow line. This situation (passing of control valve) creates two types of serious problems:
      i. Line between deluge valve and control valve may burst due to build up pressure in this line segment, because this segment is not designed for 100 kg/cm2 pressure.
      ii. If isolation valve kept closed to save this line segment, then, water flow cannot be generated during actual fire incident. Hence actual purpose of Fire-fighting could not be served.
   c. High throttling at control valve generate unbearable high noise pollution. If manpower is available at the platform, they cannot talk to each other.
   d. Due to high throttling of control valve, high vibration also take place in the line. It can damage flow line in a long run.

Objects of Invention:

The main object of the present invention is to provide a submersible water lifting assembly and automatic fire fighting system for unmanned platforms having said system that is efficient yet simple to install, energy saving, noise free, and economical.

Another object of the present invention is to provide a submersible water lifting assembly and automatic fire fighting system for unmanned platforms having said system wherein installation is possible by simple modification in existing offshore platform arrangement. This eliminates installation of additional multi-part arrangements thereby reduces the complexity in construction and operation.

Yet another object of the present invention is to provide a submersible water lifting assembly and automatic fire fighting system for unmanned platforms having said system that is self-cleaning and hence auto-maintenance.

Yet another objective of the present invention is to eliminate risk of fire, on main body of water lifting system itself, by locating it into water body.

Yet another object of the present invention is to provide a submersible water lifting assembly and automatic fire fighting system for unmanned platforms having said system that requires minimum space for installation.

Yet another object of the present invention is to provide a submersible water lifting assembly and automatic fire fighting system for unmanned platforms having said system that eliminates bulky and uneconomical installations; thereby making present invention simple and easy to install and economical.

Yet another object of the present invention is to provide a submersible water lifting assembly and automatic fire-fighting system for unmanned platforms having said system that ensures safeguard from fire; particularly to the unmanned platform and reduces the premium of insurance.

Yet another object of the present invention is to provide a submersible water lifting assembly and automatic fire fighting system for unmanned platforms having said system that requires almost no maintenance.

Yet another object of the present invention is to provide a submersible water lifting assembly and automatic fire fighting system for unmanned platforms having said system that is simple and safe to operate. It assures for valuable function of fire-fighting system.

Yet another object of the present invention is to provide a submersible water lifting assembly and automatic fire fighting system for unmanned platforms having said system that utilizes internal energy available in the flow of water injection line and eliminates the requirement of external energy sources like fuel; thereby saving said energy sources.

Yet another object of the present invention is to provide a submersible water lifting assembly and automatic fire fighting system for unmanned platforms having said system that also ensures to facilitate the utility requirements such as wash down pump.

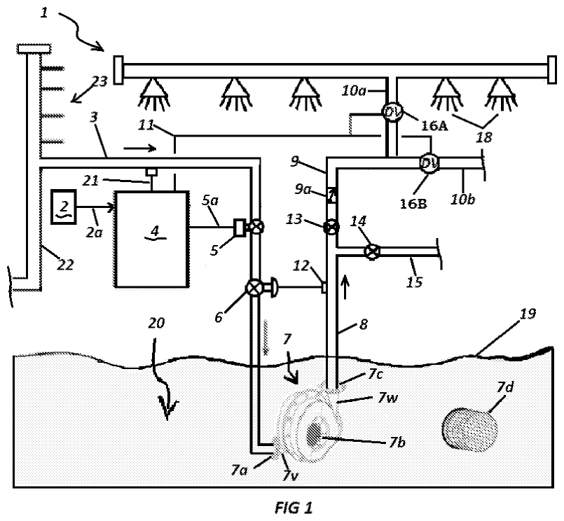

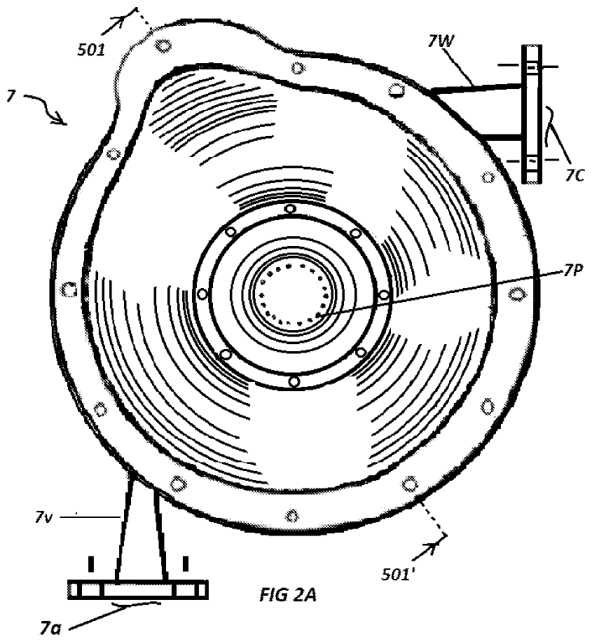

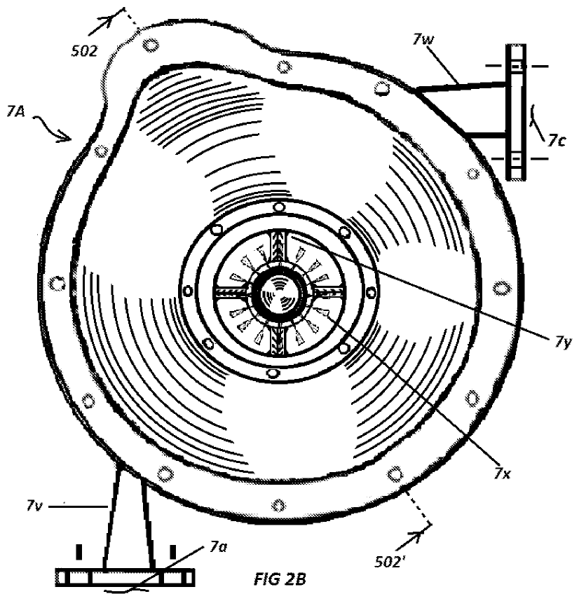

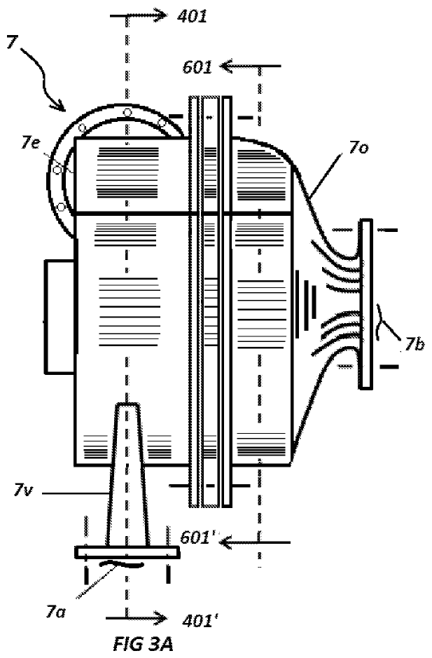

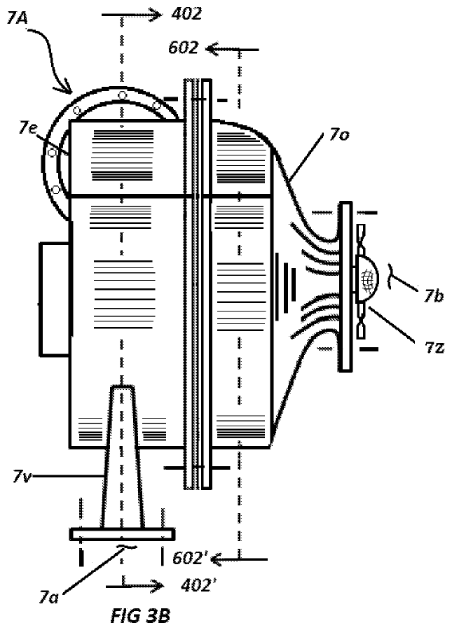

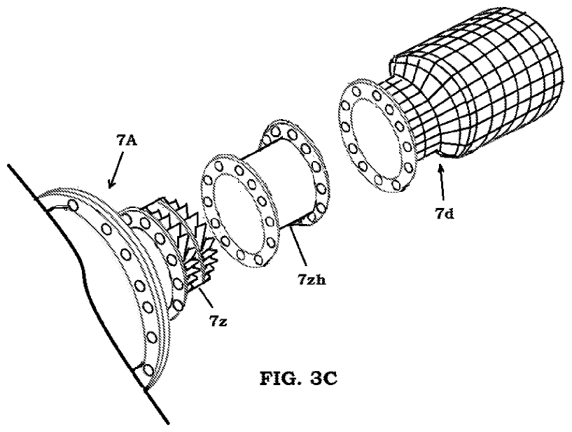

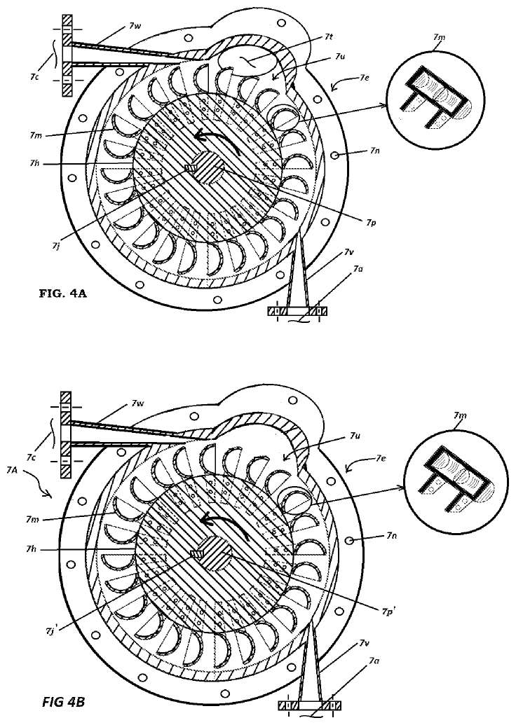

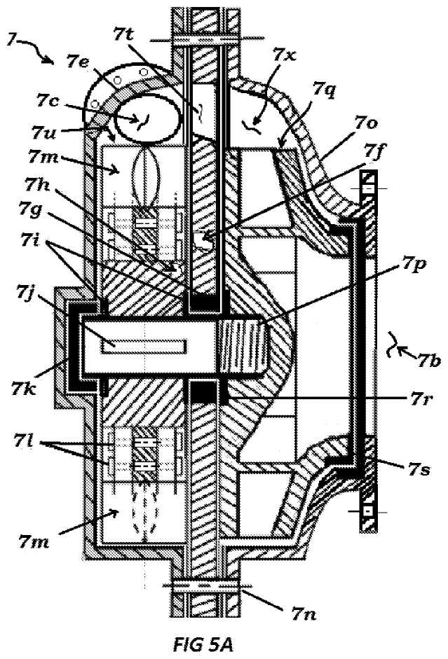

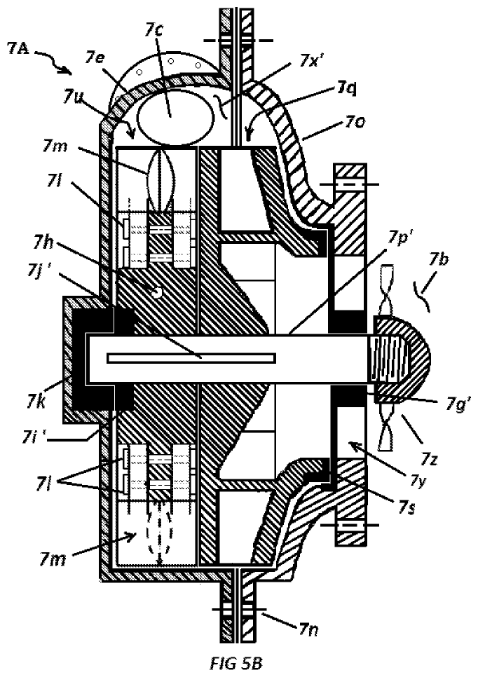

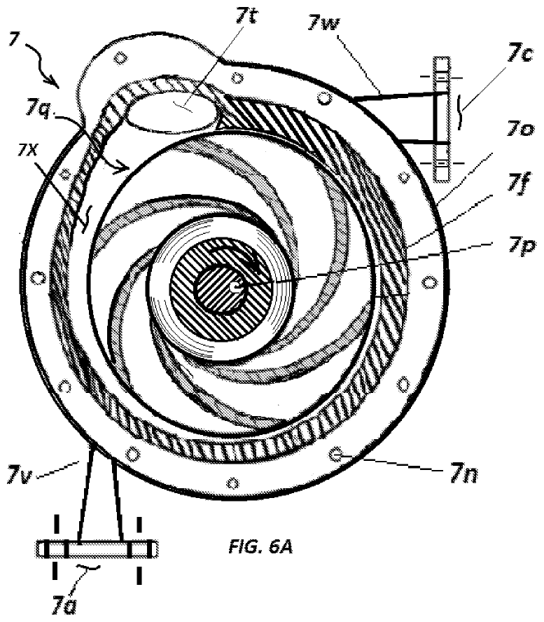

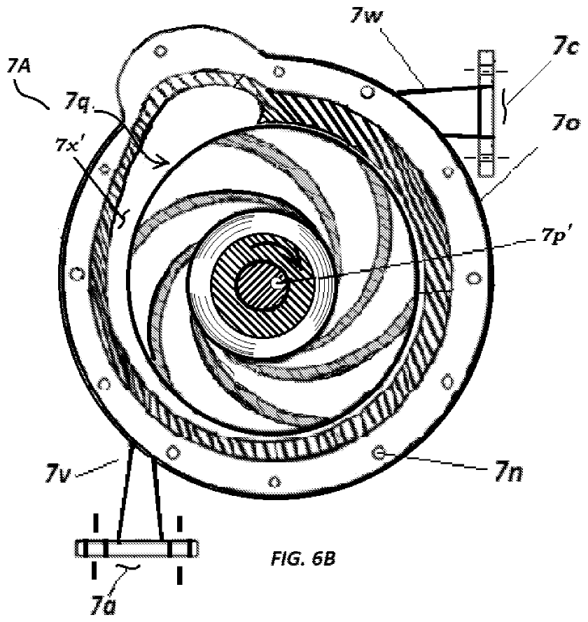

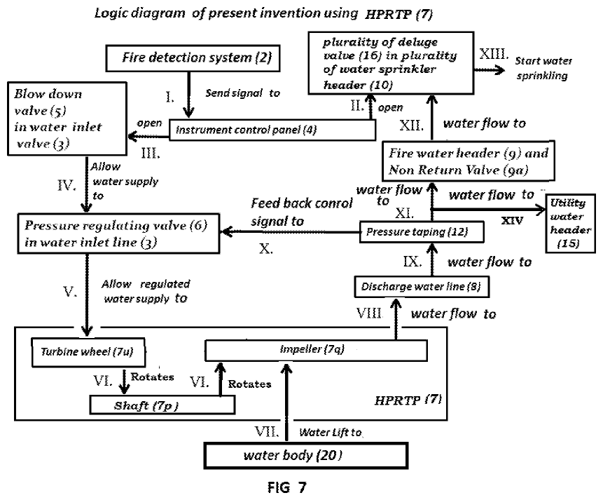

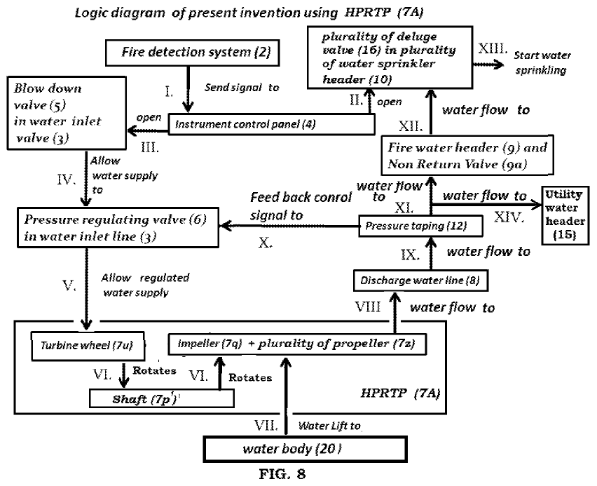

### BRIEF DESCRIPTION OF DRAWINGS

| | |
|---|---|
| FIG. 1: | Shows diagrammatic representation of present automatic |
| | firefighting system for unmanned platforms having |
| | submersible water lifting assembly |
| FIG. 2A: | Shows side view off present submersible water lifting |
| | assembly of present automatic firefighting system for |
| | unmanned platforms having said assembly |
| FIG. 2B: | Shows side view of another embodiment of the present |
| | submersible water lifting assembly of present automatic |
| | firefighting system for unmanned platforms having said |
| | assembly |
| FIG. 3A: | Shows front view of present submersible water lifting |
| | assembly of present automatic firefighting system for |
| | unmanned platforms having said assembly |
| FIG. 3B: | Shows front view of another embodiment of present |
| | submersible water lifting assembly of present automatic |
| | firefighting system for unmanned platforms having said |
| | assembly |
| FIG. 3C: | Shows partial & exploded view of another embodiment of |
| | present submersible water lifting assembly of present |
| | automatic firefighting system for unmanned platforms |
| | having said assembly with propeller housing & suction |
| | strainer |
| FIG. 4A: | Cross sectional view of present submersible water lifting |
| | assembly of present automatic fire-fighting system for |
| | unmanned platforms having said assembly; particularly |
| | showing cross section of water lifting assembly shown in |
| | FIG. 3A at 401-401′ position; illustrating the arrangement of |
| | turbine wheel engaged with shaft, water inlet, outlet and |
| | direction of rotation of water while operating said assembly. |
| | It also shows the enlarged perspective view of the bucket of |
| | the turbine wheel. |
| FIG. 4B: | Cross sectional view of another embodiment of present |
| | submersible water lifting assembly of present automatic fire- |
| | fighting system for unmanned platforms having said |
| | assembly; particularly showing cross section of water lifting |
| | assembly shown in FIG. 3B at 402-402' position; illustrating |
| | the arrangement of turbine wheel engaged with shaft, water |
| | inlet, outlet and direction of rotation of water while operating |
| | said assembly. It also shows the enlarged perspective view of |
| | the bucket of the turbine wheel. |
| FIG. 5A: | Cross sectional view of present submersible water lifting |
| | assembly of present automatic fire-fighting system for |
| | unmanned platforms having said assembly; particularly |
| | showing cross section of water lifting assembly shown of |
| | FIG. 2A at 501-501′ position; illustrating the arrangement of |
| | water inlet, turbine and impeller engaged shaft, supported |
| | by partition wall, outlet and direction of rotation of water |
| | while operating said assembly. |
| FIG. 5B: | Cross sectional view of another embodiment of the present |
| | submersible water lifting assembly of present automatic fire- |
| | fighting system for unmanned platforms having said |
| | assembly; particularly showing cross section of water lifting |
| | assembly shown in FIG. 2B at 502-502' position; illustrating |
| | the arrangement of water inlet, outlet, a propeller, stator |
| | wheel and direction of rotation of water while operating said |
| | assembly. |
| FIG. 6A: | Cross sectional view of present submersible water lifting |
| | assembly of present automatic fire-fighting system for |
| | unmanned platforms having said assembly; particularly |
| | showing cross section of water lifting assembly shown in |
| | FIG. 3A at 601-601′ position; illustrating the arrangement of |
| | impeller engaged with shaft, aperture, water inlet, outlet and |
| | direction of rotation of water while operating said assembly. |
| FIG. 6B: | Cross sectional view of another embodiment of the present |
| | submersible water lifting assembly of present automatic fire- |
| | fighting system for unmanned platforms having said |
| | assembly; particularly showing cross section of water lifting |
| | assembly shown in FIG. 3B at 602-602' position; illustrating |
| | the arrangement of impeller engaged with shaft, aperture, |
| | water inlet, outlet and direction of rotation of water while |
| | operating said assembly. |
| FIG. 7: | Shows illustrative flowchart for working of the present |
| | firefighting system with respect to embodiment HPRTP (7). |
| FIG. 8: | Shows illustrative flowchart for working of the present |
| | firefighting system with respect to embodiment HPRTP (7A). |

Meaning of Reference Numerals of Said Component Parts of Present Invention:

| | |
|---|---|
| 1: | Present automatic firefighting system for unmanned platforms |
| | having submersible water lifting assembly. (Referred herein |
| | after, as present invented system). |
| 2: | Fire detection system. |
| 2a: | Fire signal transmission line-1. |
| 3: | Water inlet line. |
| 4: | Control Panel. |
| 5: | Blow down Valve. |
| 5a: | Instrument control line. |
| 6: | Pressure Regulating Valve. |
| 7: | High Pressure Recovery Turbine Pump (referred herein after, as |
| | HPRTP). |
| 7A: | Another embodiment of HPRTP. |
| 7a: | Primary inlet. |
| 7b: | Secondary inlet. |
| 7c: | Discharge outlet. |
| 7d: | Suction Strainer. |
| 7e: | Turbine wheel housing. |
| 7f: | Partition wall. |
| 7g: | Central Hub Bushing/bearing. |
| 7g′: | Stator wheel bushing/bearing. |
| 7h: | Turbine Runner. |
| 7i: | Runner bush washers-1. |
| 7i′: | Runner bush washers-2. |
| 7j: | Shaft key-1. |
| 7j′: | Shaft key-2. |
| 7k: | Turbine end bushing or bearing. |
| 7l: | Plurality of runner hole. |
| 7m: | Plurality of turbine Bucket. |
| 7n: | Plurality of housing hole. |
| 7o: | Impeller housing. |
| 7p: | Shaft-1. |
| 7p′: | Shaft-2. |
| 7q: | Impeller. |
| 7r: | Impeller side bush washer. |
| 7s: | Impeller end bush washer. |
| 7t: | Oval shape aperture. |
| 7u: | Turbine wheel. |
| 7v: | Nozzle. |
| 7w: | Diffuser. |
| 7x: | Volute-1. |
| 7x′: | Volute-2. |
| 7y: | Stator wheel. |
| 7z: | Plurality of Propeller. |
| 7zh: | Propeller housing. |
| 8: | Discharge water line. |
| 9: | Fire water header. |
| 9a: | Non Return Valve. |
| 10: | Plurality of water sprinkler header. |
| 10a: | First Water Sprinkler Header. |
| 10b: | Second Water sprinkler Header. |
| 11: | Fire signal transmission line-2. |
| 12: | Pressure taping. |
| 13: | Fire Water Header Isolation Valve. |
| 14: | Utility Water isolation Valve. |
| 15: | Utility water line. |
| 16: | Plurality of deluge valve. |
| 16A: | Deluge Valve-1. |
| 16B: | Deluge Valve-2. |
| 18: | Plurality of Sprinklers. |
| 19: | Water surface Level. |
| 20: | Water body. |
| 21: | Supply pressure line. |
| 22: | Water injection header. |
| 23: | Plurality of water injection well. |

### SUMMARY OF THE INVENTION

Water injection systems described herein above is used by the applicant for the purpose of the present invention; in such a manner that overcomes the risks associated with high pressure. The applicant of the present invention has utilized the available high pressure water flow, in system, for its use in emergency situation of major fire. The system is developed such that the emergency as well as the purpose of fire extinguishing is served using the available water supply arrangement.

Said water injection system has main water supply line known as Water injection Header (22) from which, water can be distributed to different wells through sub-sea pipes; a water inlet line (3) is directed from said water injection header (22) at a platform to the present invented system (1) to act as a water inlet for the present invented system (1).

The applicant has developed the present invention to utilize the pressurized water for present invented system (1) such that the system controls the pressure; making it utilizable for the purpose as well as it provides a mechanism of utilizing water from the water body (20) (sea) along with it; so as to get maximum benefit of the available pressurized water placed there for oil extraction.

### DETAIL DESCRIPTION OF INVENTION

The present invention relates to a submersible water lifting assembly and automatic fire fighting system for unmanned platforms having said system (1) that is efficient yet simple to install, energy saving, noise free and economical.

More particularly, the present submersible water lifting assembly and automatic fire fighting system for unmanned platforms having said water lifting system for automatic fire-fighting [shown diagrammatically in FIG. 1], utilizes under water arrangements of unmanned platform for fire-fighting. Thus, the system is fire risk free, feasibly installed within available arrangements and is thus cost effective and easy to construct; yet is efficient. This eliminates requirement of space on platforms and ensuring fire safety of the system itself unlike the prior art.

Present submersible water lifting assembly; for the purpose of present invention; is a High Pressure Recovery Turbine Pump (7) [referred herein after as HPRTP] that utilizes under water arrangements of unmanned platform and enables the fire-fighting system to efficiently lift water from the sea water; using the force of existing water injection system; eliminating the requirement of fuel engine driven pump, for lifting the water. Thus, said High Pressure Recovery Turbine Pump (7)/HPRTP (7A) enables fire safety without use of bulky engine driven fire water pump; unlike that of the prior art.

Referring to FIGS. 2A, 3A, 4A, 5A and 6A; shows the said High Pressure Recovery Turbine Pump (7) of the present invention. Said HPRTP (7) mainly comprises of:
Primary inlet (7a),
Secondary inlet (7b),
Discharge outlet (7c),
Suction Strainer (7d),
Turbine wheel housing (7e),
Partition wall (7f)
Central Hub Bushing or bearing (7g),
Turbine Runner (7h),
Runner bush washers-1 (7i)
Shaft key-1 (7j)
Turbine end bushing or bearing (7k),
Plurality of runner hole (7l),
Plurality of turbine bucket (7m),
plurality of housing hole (7n),
Impeller housing (7o),
Shaft-1 (′7p),
Impeller (q),
Impeller side bush washer (7r),
Impeller end bush washer (7s),
Oval shape aperture (7t)
Turbine wheel (7u),
Nozzle (7v),
Diffuser(7w),
Volute-1 (7x).

Wherein said HPRTP (7) is provided to receive high pressure water from the water inlet line (3) through its primary inlet (7a) to utilize the energy of the same and create the suction within the HPRTP (7) to suck more water from the water body (20) within which the present invented system (1) is used through its secondary inlet (7b) and thereby reduce the pressure of the water and increase the amount of the water to be flown within the present invented system (1); without use of any external source of energy. The water with reduced pressure and increased amount discharges from the HPRTP (7) to the discharge water line (8) through discharge outlet (7c). A suction strainer (7d) is provided on the secondary inlet (7b) to avoid the entry of marine substances. The water, which is a mixture of initially received water from water injection system and the water received from water body (20) (sea); both together discharges from the HPRTP (7) to the discharge water line (8). It is pertinent to note that the water suction from the water body (20) (sea) is as high as enabling suction of multiple times of water flow as compared to the originally received pressurised water flow; resulting into utilization of maximum water from the abundant and free water source and eliminating wastage energy, stored in the pressurized water. It also minimise the use of high pressure water which is required for other important purposes (oil extraction). The turbine wheel (7u), comprised of turbine runner (7h) and plurality of turbine bucket (7m), is used as prime mover; run by velocity of water jet through nozzle (7v), provided at primary inlet (7a). This turbine wheel (7u), is protected and supported by turbine wheel housing (7e) and partition wall (7f). The partition wall (7l) supports central hub bushing or bearing (7g), and separates turbine wheel (7u) and impeller (7q). The shaft-1 (′7p) is supported at turbine end bushing or bearing (7k) fixed into turbine wheel housing (7e) at one end and at the central hub bushing or bearing (7g), fixed in the partition wall (7l), as a second end. The impeller end bush washer (7s), between impeller housing (7o) and impeller (7q), is provided to minimise water recycling from pump volute-1 (7x) to secondary inlet (7b) and also provides stability to impeller (7q). The discharged water from impeller volute-1 (7x) enter into diffuser (7w) through Oval shape aperture (7t) in partition wall (7l), between turbine wheel (7u) and impeller (7q) of HPRTP (7). The plurality of turbine bucket (7m) is fixed with turbine runner (7h) by tightening plurality of bolts and nuts with Plurality of runner hole (7l). Similarly, turbine wheel housing (7e), partition wall (7l) and impeller housing (7o) are boxed up by the help of bolts and nuts with plurality of housing hole (7n) as shown in the FIG. 5A. The Runner bush washers-1 (7i) in both the side of turbine runner (7h) around the shaft-1 (′7p), are provided to absorb axial thrust while rotating of turbine wheel (7u) on shaft-1 (′7p). The component, plurality of turbine bucket (7m) is specifically designed for maximum utilisation impact load of water jetting by providing both side tilted surface of partition wall inside the bucket as shown in magnified view of FIGS. 4A & 4B; which provide proper direction for acting forces of water flow. It also helps to minimise the erosive effect of water jetting on buckets of the turbine wheel. It increases water jet striking area when buckets are full of water. Since there are two compartments in the bucket, the accumulated water quantity in the bucket is less than half of the full bucket; hence loss of energy by dampening effect as well as by formation of vertex inside the bucket is very less.

Referring to FIGS. 2B, 3B, 4B, 5B and 6B; shows the said High Pressure Recovery Turbine Pump (7A); an alternative embodiment of HPRTP (7). Said HPRTP (7A) mainly comprises of:
Primary inlet (7a),
Secondary inlet (7b),
Discharge outlet (7c),
Suction Strainer (7d),
Turbine wheel housing (7e),
Stator wheel Bushing or bearing (7g′)
Turbine Runner (7h),
Runner bush washers-2 (7i′)
Shaft key-2 (7j′)
Turbine end bushing or bearing (7k),
Plurality of runner hole (7l),
Plurality of turbine bucket (7m),
plurality of housing hole (7n),
Impeller housing (7o),
Shaft-2 (7p′),
Impeller (q),
Impeller end bush washer (7s),
Turbine wheel (7u),
Nozzle (7v),
Diffuser (7w),
Volute-2 (7x′),
Stator wheel (7y),
Plurality of Propeller (7z);
Propeller housing (7zh)

Wherein; the turbine wheel (7u) and impeller (7q) are coupled together in a shaft-2 (7p′) with the help of shaft key-2 (7j′). The components, plurality of propeller (7z) and stator wheel (7y) are engaged with impeller housing (7o) and shaft-2 (7p′). The one end of the shaft-2 (7p′) is supported at the turbine wheel housing (7e) and other end of shaft-2 (7p′) is supported at stator wheel (7y) (refer to FIG. 2B and FIG. 5B) provided at the suction end of impeller housing (7o). Turbine wheel housing (7e) is provided to protect turbine wheel (7u) from external water body (20) and support shaft-2 (7p′). Similarly, the impeller housing (7o) is provided to protect impeller (7q) and support shaft-2 (7p′), through stator wheel (7y) at the other end, with the help of stator wheel bushing or bearing (7g′). The housings, turbine wheel housing (7e) and impeller housing (7o) are boxed up together with the help of bolts and nuts through plurality of housing hole (7n) as shown in FIG. 5B. The plurality of propeller (7z) is provided to boost up water flow into impeller (7q), to raise suction pressure of water flow. The plurality of propeller (7z) is internally threaded to fix with shaft-2 (7p′) which is externally threaded at one end. Now the embodiment HPRTP (7A) functions as multi stage centrifugal pump. The stator wheel bushing or bearing (7g′) and turbine end bushing or bearings (7k) are provided for smooth rotation of shaft-2 (7p′) along with turbine wheel (7u), impeller (7q) and plurality of propeller (7z). The turbine wheel (7u), and impeller (7q) are engaged with shaft-2 (7p′) by shaft key-2 (7j′) The Runner bush washers-2 (7i′) is provided to absorb axial thrust between turbine wheel (7u) and turbine end bushing or bearing (7k), exerted while rotation of turbine wheel (7u). The stator wheel (7y) provides support to shaft-2 (7p′) through stator wheel bushing or bearing (7g′) and the impeller housing (7o). As soon as water flow start in water inlet line (3), initiated by fire detection system (2) of platform; water enters into primary inlet (7a) through nozzle (7v). The water jet starts hitting on plurality of turbine bucket (7m) of turbine wheel (7u) attached by turbine runner (7h), through nuts and bolts with Plurality of runner hole (7l). The impact of water jet on plurality of turbine bucket (7m) of turbine wheel (7u); creates rotational motion of turbine wheel (7u). As the turbine wheel (7u) is coupled with impeller (7q) and plurality of propeller (7z), by same shaft-2 (7p′); both start rotating with turbine wheel (7u). As the plurality of propeller (7z) rotates, sucks the water, through secondary inlet (7b) and suction strainer (7d); pushes the water flow to suction of impeller (7q), through propeller hosing (7zh); wherein impeller (7q) alone functions as a single stage centrifugal pump; the plurality of propeller (7z) help to boost the suction pressure, the total effect is just like a multi stage centrifugal pump. The water flow, generated by rotation of impeller (7q), and plurality of propeller (7z), passes through volute-2 (7x′), discharge outlet (7c) and diffuser (7w) to fire water header (9) for fire-fighting. The impeller end bush washer (7s) is provided to absorb axial thrust and minimise the recycling of water from discharge outlet (7c) to secondary inlet (7b). The said turbine wheel housing (7e) and impeller housing (7o) are boxed up by the help of bolts and nuts with plurality of housing hole (7n). Similarly, suction strainer (7d), propeller housing (7zh) & impeller housing (7o) are boxed up with nuts & bolts as shown in FIG. 3C (partial & exploded view of HPRTP (7A), propeller housing (7zh) & suction strainer (7d).)

Referring to FIG. 1; which shows preferred embodiments of the present invention; wherein water injection system of a platform of oil and gas industry is utilized to provide present automatic fire fighting system for offshore platforms that is easy to install and operate; yet is efficient and economical. Said system (1) mainly comprises of:
Fire detection system (2).
Fire signal transmission line-1 (2a),
Water inlet line (3),
Control Panel (4),
Blow down Valve (5),
Instrument control line (5a),
Pressure Regulating Valve (6),
High Pressure Recovery Turbine Pump (7) (referred herein after as HPRTP), or
HPRTP (7A), an alternative of HPRTP (7).
Discharge water line (8).
Fire water header (9).
Non Return Valve (9a),
Plurality of water sprinkler header (10).
First water sprinkler header (10a).
Second water sprinkler header (10b).
Fire signal transmission line-2 (11).
Pressure taping (12).
Fire Water Header Isolation Valve (13),
Utility Water isolation Valve (14),
Utility water line (15),
Plurality of deluge valve (16)
Deluge valve-1 (16A),
Deluge valve-2 (16B),
Plurality of Sprinklers (18),
Water surface level (19),
Water body (20) (Generally sea)
Supply pressure line (21),
Water injection header (22).
Plurality of Water Injection Wells (23).

Wherein; the water inlet line (3) is connected, with water injection header (22) same way as plurality of water injection wells (23) is connected with said water injection header (22); for operation of present invented system (1) where water injection header (22) is part of platform. The fire signal transmission line-1 (2a) transmit fire signal from fire detection system (2) to control panel (4) where fire detection system (2) is part of platform (fire detection system is a part of oil & gas process, for well closer and process shut down).

The blow down valve (5), Pressure Regulating Valve (6), deluge valve-1 (16A), deluge valve-2 (16B), isolation valves (13), isolation valve-2 (14), and plurality of sprinklers (18) are shown symbolically in the drawing.

The exploded pictorial view of component HPRTP (7) is shown with indication of primary inlet (7a), secondary inlet (7b), discharge outlet (7c), nozzle (7v), diffuser (7w) and suction strainer (7d). The drawings shown are conceptual view of entire system.

Fire detection system (2); which is part of oil and gas operation, at platforms is utilized for obtaining fire signal though fire signal transmission line-1 (2a), to activate the present invented system (1) for fire fighting.

Water inlet line (3) tapped from Water injection header (22) provides pressurized water to the present invented system (1). The inflow of water from the water inlet line (3) and is controlled by pressure regulating valve (6) Said water has a high pressure and cannot be used for the purposes of extinguishing the fire. Thus, a mechanism of pressure control is provided in the said system (1) to best utilize the available source of water for fire extinguishing through present invented system (1). The fire signal received by Control Panel (4) though fire signal transmission line-1 (2a), from fire detection system (2); activates blow down valve (5), through instrument control line (5a), and allows pressurised water to enter the said system (1), through water inlet line (3). Simultaneously control panel (4) send fire signal to open plurality of deluge valve (16) [deluge valve-1 (16A) or deluge valve-2 (16B) or both or more] though fire signal transmission line-2 (11). A Pressure Regulator Valve (6) regulates pressure of the water flow; which is in turn facilitated by the Pressure taping (12). A submersible water lifting system is provided to receive high pressure water from the water inlet line (3) through its primary inlet (7a) to utilize the energy of the same and create the suction within the HPRTP (7)/(7A) to suck more water from the water body (20) (sea), within which the present invented system (1) is used, through its secondary inlet (7b) and thereby reduce the pressure of the water and increase the amount of the water to be flown within the system; without use of any external source of energy. The water with reduced pressure and increased amount discharges from the HPRTP (7) or HPRTP (7A), to the discharge water line (8) through discharge outlet (7c). A suction strainer (7d) is provided on the secondary inlet (7b) to avoid the entry of marine substances. The water, which is a mixture of initially received water from water injection system and the water received from water body (20) (sea); both together discharges from the HPRTP (7) or HPRTP (7A), to the discharge water line (8). It is pertinent to note that the water suction from the water body (20) is as high as enabling suction of multiple times of water flow as compared to the originally received pressurised water flow; resulting into utilization of maximum water from the abundant and free water source and eliminating wastage energy, stored in the pressurized water. It also minimise the use of high pressure water which is required for other important purposes. The water from discharged water line (8), reaches to plurality of water sprinkler header (10), through non return valve (9a) & fire water header (9); to spray water, over fire caught area, through plurality of Sprinklers (18). Plurality of water sprinkler headers (10) are provided to sprinkle water on fire caught area; amongst which, a First Water Sprinkler Header (10a) is provided to sprinkle water in upper deck and a Second Water sprinkler header (10b) is provided to sprinkle water in lower deck. There are Non-Return Valve (9a) provided in the system to facilitate single side flow of water for fire-fighting.

Plurality of deluge valve (16) is provided to allow passing of water to said First Water Sprinkler Header (10a) or Second Water sprinkler header (10b) or both or more; depending upon the area in which fire has taken place. This directs the water to the fire affected area only; and avoids wastage of water by blocking passage of water in other areas. Further, depending on the number of water sprinkler headers, arranged in different regions of the platform; plurality of deluge valve (16) is provided to facilitate in directing the water flow in area where fire is existing.

The control panel (4) is preferably powered by water pressure taken from water inlet line (3) through supply pressure line (21); or otherwise it can also be powered by pneumatic/electric power as per location where system is used.

The submersible water lifting assembly of present automatic fire-fighting system is placed below Water surface level (19) of water body (20) (see FIG. 1) facilitating utilization of sea water for fire-fighting along with operational advantages and protection of said assembly itself from fire.

Present invented system (1) also has provisions to allow the water to be used for other purposes including cleaning. Fire Water Header Isolation Valve (13) is thus provided; which can be closed and Utility Water isolation Valve (14) can be opened so as to allow said resultant water to pass through Utility water header (15) for said purposes.

Additionally, Fire Water Header Isolation Valve (13) and Utility/service Water isolation Valve (14); both can be closed to ensure water discharge from secondary inlet (7b) into the water body (20) (sea), for cleaning of the suction strainer (7d). This ensures there is no blockage and allows ready infusion of water through secondary inlet (7b). This makes the maintenance simple and efficient. Also, there is no requirement of rendering the platform at risk of fire, during maintenance of fire-fighting system unlike the prior arts.

Wherein modifications in the present invented system (1) for accommodating present water lifting assembly i.e. HPRTP (7) or HPRTP (7A), involves the modifications in terms elimination of complex arrangements of air/gas start up vessel, diesel storage vessel, diesel tank, diesel engine, gear box, multi stage centrifugal pump, vertical column casing, 40 meter length heavy duty shaft and related arrangements of its supply and usage during operation of said prior art system. The elimination of said parts results in simplified rearrangement of remaining parts to provide a simple yet efficient said system (1) as shown in FIG. 1 and as described herein. The obtained present invented system (1) utilizes novel water lifting system HPRTP (7) and HPRTP (7A), as described herein above; which works without requirement of external energy sources and avoids wastage of water; yet is efficient in supplying water to the present invented system (1) for extinguishing fire; even at an unmanned platform.

Further, herein before disclosed are the preferred embodiments of the present invented systems (1) with reference to accompanying drawings.

Here, it is to be noted that the present invention is not limited thereto and can be used for varied applications including fire fighting systems for onshore and water transport systems for transporting water from lower level to higher levels. The components like flow meters, drain line tapings with drain valves, pressure gauges, blinds, plugs, isolation valves etc are not shown in the Figure & not described is understood 86 still in the scope of the intervention Furthermore, the component parts described are not meant there to limit its operating, and any rearrangement of the component parts for achieving the same functionality is still within the spirit and scope of the present invention. It is to be understood that the drawings are not drawn to scale and are only for illustration purposes.

Working of the Invention:

Referring to FIGS. 1, 4A, 5A, 6A and 7: with respect to embodiment of the present invention; the working steps are as under:
I. When fire take place in any area of platform, the fire detection system (2) sends the fire signal to control panel (4) through fire signal transmission line-1 (2a).
II. Said fire signal is further transmitted to plurality of deluge valve (16) [deluge valve-1 (16A) or deluge valve-2 (16B) or both or more] through fire signal transmission line-2 (11) of area where fire took place. And opens deluge valve accordingly.
III. The Control Panel (4) simultaneously sends signal to open blow down valve (5) existing in water inlet line (3); through instrument control line (5a).
IV. Said blow down valve (5), when open, allows water flow from water injection header (22), attached with plurality of water injection wells (23); through the water inlet line (3); to enter into pressure regulating valve (6).
V. The pressure regulating valve (6), regulates the pressure of water flow and allows water flow to enter into nozzle (7v) of HPRTP (7) which is placed below Water surface level (19) into water body (20), through primary inlet (7a).
VI. The nozzle (7v) converts water flow into high velocity water jet and strike on plurality of turbine bucket (7m) mounted on turbine runner (7h) of turbine wheel (7u), rotates shaft-1 (′7p) attached with the turbine wheel (7u); by the impact of water jetting. Since turbine wheel (7u) is coupled with impeller (7q); impeller (7q) also starts rotating with the same speed of turbine wheel (7u).
VII. The rotating impeller (7q) function as centrifugal pump and start water lifting from water body (20), though secondary inlet (7b) and suction strainer (7d).
VIII. Lifted water by rotating impeller (7q), passes through volute-1 (7x), diffuser (7w), discharge outlet (7c) and discharge water line (8).
IX. The water flow from discharge water line (8), passes through pressure taping (12), where it detects the pressure of water flow in discharge water line (8).
X. The pressure detected taped water, from pressure taping (12), gives the pressure feedback to pressure regulating valve (6). To regulate the pressure of supply for HPRTP (7) in turn, as per requirement, set into pressure regulating valve (6). It controls the pressure of discharge water line (8) as per requirement.
XI. As the fire water header isolation valve (13) is normally opened and utility header isolation valve (14) is normally closed; the pressure controlled flow in discharged water line (8) passes to fire water header (9) through non-return valve (9a). Hence fire water header (9) gets filled by this water flow.
XII. The water in said fire water header (9), passes to plurality of deluge valve (16), through plurality of water sprinkler header (10).
XIII. Said plurality of deluge valve (16), being already opened by action Two (“II”) of control panel (4), water flow passes to plurality of sprinklers (18); sprinkling of water start over fire caught area, detected by fire detection system (2).
XIV. If water is needed for other purposes like utility water for cleaning or testing of flow rate or regular maintenance etc, the utility water header (15) can be used by opening of isolation valve (14) of utility header (15), and simultaneously closing fire water header isolation valve (13) or without closing of fire water header isolation valve (13), as plurality of deluge valve (16) are normally remain closed, except fire emergency.

Referring to FIGS. 1, 4B, 5B, 6B and 8; with respect to another embodiment of the present invented system (1); working steps are as under:
I. When fire take place in any area of platform, the fire detection system (2) sends the fire signal to control panel (4) through fire signal transmission line-1 (2a).
II. Said fire signal is further transmitted to plurality of deluge valve (16) [deluge valve-1 (16A) or deluge valve-2 (16B) or both or more] through fire signal transmission line-2 (11) of area where fire took place. And opens deluge valves accordingly.
III. The Control Panel (4) simultaneously sends signal to open blow down valve (5) existing in water inlet line (3), through instrument control line (5a).
IV. Said blow down valve (5), when open, allows water flow from water injection header (22), attached with plurality of water injection wells (23); through the water inlet line (3); to enter into pressure regulating valve (6).
V. The pressure regulating valve (6), regulate the pressure of water flow and allows water flow to enter into nozzle (7v) of HPRTP (7A), through primary inlet (7a).
VI. The nozzle (7v) convert water flow into high velocity water jet and strike on plurality of turbine bucket (7m) mounted on runner of turbine wheel (7u), rotates shaft (‘7p’) attached with this turbine wheel (7u); by the impact of water jetting. Since turbine wheel (7u) is coupled with impeller (7q) and plurality of propeller (7z), both start rotating with the same speed of turbine wheel (7u).
VII. The rotating impeller (7q) and plurality of propeller (7z), function as multi stage centrifugal pump and start water lifting from water body (20), though secondary inlet (7b) and suction strainer (7d).
VIII. Lifted water by rotating impeller (7q), passes through volute-2 (7x′), diffuser (7w), discharge outlet (7c) and discharge water line (8).
IX. The water flow from discharge water line (8), passes through pressure taping (12), where it detects the pressure of water flow in discharge water line (8)
X. The pressure detected taped water from pressure taping (12), gives the pressure feedback to pressure regulating valve (6). To regulate the pressure of supply water for HPRTP (7A) in turn, as per requirement, set into pressure regulating valve (6). It controls the pressure of discharge water line (8) as per requirement.
XI. As the fire water header isolation valve (13) is normally opened and utility header isolation valve (14) is normally closed; the pressure controlled flow in discharged water line (8), passes to fire water header (9) through non-return valve (9a). Hence fire water header (9) gets filled by this water flow.
XII. The water in said fire water header (9), passes to plurality of deluge valve (16), through plurality of sprinkler header (10).
XIII. Said plurality of deluges (16) being opened by action “II” (as described in action “II” earlier above) of control panel (4), water flow passes to plurality of sprinklers (18); sprinkling of water start over fire caught area detected by fire detection system (2).
XIV. If water is needed for other purposes like utility water for cleaning or testing of flow rate or regular maintenance etc, the utility water header (15) can be used by opening of isolation valve (14) of utility header (15), and simultaneously closing fire water header isolation valve (13) or without closing of fire water header isolation valve (13), as plurality of deluge valve (16) are normally remain closed, except fire emergency.
The control panel (4) can be operated by pneumatic pressure, gas pressure or hydraulic pressure which ever available on the platform. The Supply pressure line (21) is provided for this purpose only.

Inlet water flow from water inlet line (3) to the HPRTP (7) or HPRTP (7A), is known as primary flow and inlet water flow from water body (20) to HPRTP (7) or HPRTP (7A), is known as secondary flow. Whereas these both the flows mix together and travel towards fire water header (9) is known as generated flow or discharged flow. These generated flow depends upon parameters, inlet flow rate Qₚ, pressure of inlet flow Pₚ, flow ratio M (secondary flow rate to primary flow rate). Secondary pressure Pₛ, discharge pressure (needed pressure) P_{d}, nozzle diameter Aₙ, efficiency η etc.

### Example 1

In High Pressure Recovery Turbine Pump (HPRTP), applied parameters, 16 mm diameter of nozzle (7v), primary water supply flow pressure 100 kg/cm2, secondary water inlet suction pressure 2 kg/cm2 and required desired pressure 10 kg/cm2, the efficiency observed is 0.6, with the resultant discharged flow rate 600 m3/hr.

Given below table 1 provides information of discharge flow rate with respect to provided other parameters of the system.

| Perameters | 1 | 2 | 3 | 4 | 5 | 6 | 7 |
|---|---|---|---|---|---|---|---|
| Inlet pipe diameter | 2″ | 2″ | 2″ | 2″ | 2″ | 2″ | 2″ |
| in inch | | | | | | | |
| Outlet pipe | 6″ | 6″ | 6″ | 6″ | 6″ | 6″ | 6″ |
| diameter in inch | | | | | | | |
| Secondary pressure | 2 | 2 | 2 | 2 | 2 | 2 | 2 |
| kg/cm2 | | | | | | | |
| Primary pressure | 100 | 90 | 110 | 100 | 100 | 100 | 100 |
| kg/cm2 | | | | | | | |
| Primary flow rate | 100 | 100 | 100 | 90 | 110 | 100 | 100 |
| Qₚ in m3/hr | | | | | | | |
| Velocity of primary | 13.7 | 13.7 | 13.7 | 12.3 | 15.1 | 13.7 | 13.7 |
| flow Vₚ in m/s | | | | | | | |
| Discharge pressure | 10 | 10 | 10 | 10 | 10 | 12 | 8 |
| (kg/cm2) | | | | | | | |
| Pump efficiency η | 0.6 | 0.6 | 0.6 | 0.6 | 0.6 | 0.6 | 0.6 |
| Flow ratio M | 5 | 4.42 | 5.6 | 5 | 5 | 4 | 6.5 |
| Discharge flow rate | 600 | 542 | 660 | 540 | 660 | 500 | 750 |
| Q_{d} m3/hr | | | | | | | |

Table 1 provides information of discharge flow rate with respect to provided other parameters of the system.

Illustration:

From the table 1, it is observed that keeping primary pressure head constant, as discharged head increases, the total discharged flow rate (Qd) decreases and similarly, keeping discharged pressure head constant, it is observed that the total discharged flow rate (Qd) increases with rising of primary pressure head. So the HPRTP (7) can be use for wide range of capacity by adjusting parameters of the pump.

### Example 2

In High Pressure Recovery Turbine Pump (HPRTP) (7A), applied parameters, 16 mm diameter of nozzle (7v), primary water supply flow pressure 100 kg/cm2, secondary water inlet suction pressure 2 kg/cm2 and required desired pressure 15 kg/cm2, the efficiency observed is 0.6, with the resultant discharged flow rate 500 m3/hr.

Given below table 2 provides information of discharge flow rate with respect to provided other parameters of the system.

| Parameters | 1 | 2 | 3 | 4 | 5 | 6 | 7 |
|---|---|---|---|---|---|---|---|
| Inlet pipe diameter | 2″ | 2″ | 2″ | 2″ | 2″ | 2″ | 2″ |
| in inch | | | | | | | |
| Outlet pipe | 6″ | 6″ | 6″ | 6″ | 6″ | 6″ | 6″ |
| diameter in inch | | | | | | | |
| Secondary pressure | 2 | 2 | 2 | 2 | 2 | 2 | 2 |
| kg/cm2 | | | | | | | |
| Primary pressure | 100 | 90 | 110 | 100 | 100 | 100 | 100 |
| kg/cm2 | | | | | | | |
| Primary flow rate | 100 | 100 | 100 | 90 | 110 | 100 | 100 |
| Qₚ in m3/hr | | | | | | | |
| Velocity of primary | 13.7 | 13.7 | 13.7 | 12.3 | 15.1 | 13.7 | 13.7 |
| flow Vₚ in m/s | | | | | | | |
| Discharge pressure | 15 | 15 | 15 | 15 | 15 | 17 | 13 |
| kg/cm2 | | | | | | | |
| Pump efficiency η | 0.6 | 0.6 | 0.6 | 0.6 | 0.6 | 0.6 | 0.6 |
| Flow ratio M | 4 | 3.6 | 4.6 | 4 | 44 | 3.53 | 4.6 |
| Discharge flow rate | 500 | 460 | 560 | 500 | 540 | 453 | 460 |
| Q_{d} m3/hr | | | | | | | |

Table 2 provides information of discharge flow rate with respect to provided other parameters of the system

Illustration:

From the table, it is observed that discharge flow rates are comparatively lower then example 1. That is because the discharge pressure head increased at the cost of flow rates. Similarly as in example 1, keeping primary pressure head constant, as discharged head increases the total discharged flow rate (Qd) decreases and similarly, keeping discharged pressure head constant it is observed that the total discharged flow rate (Qd) is increased with raising of primary pressure head. So the pump can be use for wide range of capacity by adjusting parameters of the HPRTP (7A).

Comparison of Prior Art and Present Invention

The typical prior art (or traditional arts) and the present invention are hereby compared in the below table to clearly bring out the technical differences between the prior art and the present invention.

A comparison is done between the prior art (or traditional) turbine pumps and the submersible water lifting assembly (HPRTP) of the present invention through the values of various parameters and its impact. This clearly depicts the disadvantages of the prior arts (or traditional) systems; thereby establishing the need for the present invention.

TABLE 3
Comparative analysis of existing turbine pumps with present submersible water
lifting assembly (HPRTP) used in present automatic fire-fighting system.

| | | Prior Art Pumps | | |
|---|---|---|---|---|
| | | (Turbine Pumps) | Invented Pump | Disadvantage of |
| Sr. No. | Parameters | Normal Range | (HPRTP (7) & (7A) | prior arts |
| 1) | Supply/ | 1 Kg/cm2 to | Not less than 70 | Prior arts Can't |
| | primary | 50 kg/cm2 | kg/cm2 | generate high |
| | pressure. | | | discharge flow |
| | | | | which is most |
| | | | | important for |
| | | | | firefighting, at this |
| | | | | supply pressure. |
| | | | | The present |
| | | | | invention is |
| | | | | designed for high |
| | | | | flow rate. |
| 2) | Secondary/ | 0 to 2 kg/cm2 | Not less than 2 | In prior arts cavity |
| | suction | | kg/cm2 | formation is |
| | Pressure. | | | possible if operated |
| | | | | at high primary |
| | | | | pressure, whereas |
| | | | | this problem is |
| | | | | solved in present |
| | | | | invention. |
| 3) | Discharge | 0 to 10 | 0 to 15 kg/cm2 | Range of pressure |
| | Pressure. | kg/cm2 | | of prior art is |
| | | | | smaller than the |
| | | | | range of pressure in |
| | | | | present invention |
| | | | | i.e. present |
| | | | | invention can use |
| | | | | at wide range of |
| | | | | discharge pressure |
| 4) | Primary | 1 m3/hr to 10 | 100 m3/hr to | In prior arts, it is |
| | Flow. | m3/hr | 200 m3/hr | very small flow |
| | | | | compare to present |
| | | | | invention. It is big |
| | | | | disadvantage of |
| | | | | prior arts, since it |
| | | | | can't generate large |
| | | | | discharge flow for |
| | | | | fire fighting. |
| 5) | Secondary | 1 m3/hr to 2 | 200 m3/hr to | In prior arts, it is |
| | Flow. | m3/hr | 1000 m3/hr | very small flow |
| | | | | compare to present |
| | | | | invention. It is big |
| | | | | disadvantage of |
| | | | | prior arts, since it |
| | | | | can't generate large |
| | | | | discharge flow for |
| | | | | fire fighting |
| 6) | Flow Ratio. | Less the 1 | Greater the 2 | Serious |
| | | | | disadvantage of |
| | | | | prior art having less |
| | | | | efficiency over |
| | | | | present invented |
| | | | | system. |
| 7) | Discharge | 1 m3 to 20 | Greater than | Biggest |
| | flow | m3/hr | 200 m3/hr | disadvantage of |
| | | | | prior art having |
| | | | | very less discharge |
| | | | | flow than the |
| | | | | discharged flow of |
| | | | | present invention. |
| 8) | Types of | Kaplan, Francis | Preferably | Prior arts turbines |
| | turbine | or Turgo but | Pelton Turbine | can't give higher |
| | used | pelton cannot | used. But all | efficiency at high |
| | | be used | type can be | pressure like Pelton |
| | | | used | turbine. |
| 9) | size of | Small | Larger | Prior art can't |
| | turbine | | | generate as high |
| | used | | | flow as generated |
| | | | | by present invented |
| | | | | system. |
| 10) | Size of | Small | Larger | Prior art can't |
| | impeller | | | generate flow as |
| | used | | | high as generated |
| | | | | by present invented |
| | | | | system. |
| 11) | Outlet flow | Separate | Combine output | In prior arts it may |
| | of turbine | output | | be wastage of |
| | and impeller | | | energy or material if |
| | | | | not re-utilized the |
| | | | | same. Such thing |
| | | | | cannot happen in |
| | | | | present invention. |
| 12) | Main | To lift water | To multiply flow | The prior arts are |
| | objective | from low level | rate along with | not designed for |
| | | where | recovery of | high flow rate for |
| | | atmospheric | energy where | firefighting and |
| | | pressure is | flow rate is most | automatic operation |
| | | insufficient for | important. It is | without assistance |
| | | centrifugal | designed for | of man. It is main |
| | | pump. | emergency | disadvantage of |
| | | To recover | requirement for | prior arts compare |
| | | energy of | firefighting and | to present |
| | | another pump | more | invention. |
| | | in use. | particularly | |
| | | | automatic fire | |
| | | | fighting for | |
| | | | unmanned | |
| | | | platform where | |
| | | | man is not | |
| | | | residing round | |
| | | | the clock. | |
| 13) | Flexibility to | Not possible | Provided for | Prior arts are not |
| | revert | due to Non | regular Strainer | applicable to such |
| | direction of | Return Valve in | cleaning | marine environment |
| | secondary | the suction line | (Marine Growth | where cleaning of |
| | Flow. | or primary and | Removal). | suction strainer is |
| | | secondary flows | | needed frequently. |
| | | are not mixed | | |
| | | at all. | | |
| 14) | construction | It is in two | It is in mono | This type of |
| | | parts, impeller | block, with or | construction in |
| | | and turbine. | without | prior art is |
| | | Both are | partition wall | disadvantageous for |
| | | separated | between | firefighting at |
| | | either by | impeller and | unmanned platform |
| | | sealing | turbine. It is | and marine |
| | | arrangement if | compact | environment. I.e. |
| | | connected by | structure | Size, shape, |
| | | common shaft | without sealing | capacity & Non |
| | | or by belt | arrangement. | Return Valve at |
| | | arrangement if | It has two | suction strainer in |
| | | not connected | inlets, one for | prior arts, are not |
| | | by common | impeller part, | suitable at offshore |
| | | shaft. | and other for | environment. |
| | | It has two | turbine part, | |
| | | inlets, one for | and one | |
| | | turbine part | common outlet | |
| | | and another for | for both part | |
| | | impeller part. | Non Return | |
| | | And two | Valve is not | |
| | | outlets, one for | installed in | |
| | | turbine part | suction line | |
| | | and another for | specifically to | |
| | | impeller part. | allow reverse | |
| | | Non Return | flow to clean | |
| | | Valve is | suction strainer | |
| | | installed in | whenever | |
| | | suction line to | require. | |
| | | stop reverse | | |
| | | flow. | | |

A further comparison is done between an existing fire fighting system and the present automatic fire fighting system having a submersible water lifting assembly (HPRTP). Table 4 herein below shows a component wise distinction between the prior art and the present invention.

TABLE 4
Component wise differences of prior art and present invention.

| | | Prior art | | | Present Invented system | | |
|---|---|---|---|---|---|---|---|
| | | Is it | Disadvantage/ | | Is it | | |
| | | part | Problems/ | | part | Advantages of | |
| | | of | Draw backs of | | of | present invention | |
| Sr. No. | Components | system? | prior art | | System? | Over prior art | |
| 1) | Fire Engine | Yes | Huge size fire | | No | HPRTP assembly is | |
| | | | engine is used | | | used in place of | |
| | | | with gear box, | | | engine & pump and | |
| | | | air/gas start-up | | | it is located below | |
| | | | vessels etc. | | | sea level, | |
| | | | 1. | Needs space on | | 1. | Doesn't require |
| | | | | platform. | | | any space. |
| | | | 2. | Needs regular | | 2. | Doesn't require |
| | | | | maintenance. | | | regular |
| | | | 3. | Needs fuel. | | | maintenance. |
| | | | 4. | Needs | | 3. | Doesn't require |
| | | | | lubricant. | | | fuel, as it is |
| | | | 5. | Needs fire proof | | | powered by |
| | | | | exhaust line. | | | injection water |
| | | | 6. | Needs complex | | | flow. |
| | | | | start-up | | 4. | Doesn't require |
| | | | | system. | | | lubricant. |
| | | | 7. | Needs fuel tank. | | 5. | Doesn't need fire |
| | | | 8. | Needs start-up | | | proof exhaust, |
| | | | | air or gas | | 6. | Simple start-up |
| | | | | storage vessel. | | | system. |
| | | | 9. | Large fire can | | 7. | No need of fuel |
| | | | | damage fuel | | | tank. |
| | | | | storage tank. | | 8. | No need of start- |
| | | | 10. | Needs fire | | | up air or gas |
| | | | | protection wall. | | | storage vessel. |
| | | | | | | 9. | Large fire can't |
| | | | | | | | damage system as |
| | | | | | | | HPRTP assembly |
| | | | | | | | is placed below |
| | | | | | | | sea level |
| | | | | | | 10. | No need of fire |
| | | | | | | | protection wall as |
| | | | | | | | HPRTP assembly |
| | | | | | | | is place below sea |
| | | | | | | | level. |
| 2) | Gear Box | Yes | As there is gear | | No | As there is no gear | |
| | Assembly. | | box in the system | | | box in the system. | |
| | | | 1. | Needs | | 1. | It eliminates |
| | | | | maintenance | | | maintenance |
| | | | 2. | Chance of | | 2. | No Chance of |
| | | | | failure | | | failure. |
| 3) | Pump | Yes | As there are | | No | As there is no Pump | |
| | Column shaft | | Pump Column | | | Column and shaft in | |
| | between gear | | and shaft in the | | | the system. | |
| | box and | | system. | | | 1. | Eliminates |
| | pump | | 1. | Difficult to lift | | | maintenance. |
| | | | | these items at | | 2. | Decreases the |
| | | | | deck level, for | | | cost of firefighting |
| | | | | pump | | | system. |
| | | | | maintenance | | | |
| | | | 2. | Increases the | | | |
| | | | | cost of | | | |
| | | | | firefighting | | | |
| | | | | system | | | |

| | | | | | |
|---|---|---|---|---|---|
| 4) | Fire water | Yes | Increases the | no | As there is no |
| | pump column | | cost of | | column casing |
| | casing. | | firefighting | | needed, it reduces |
| | | | system | | the cost of fire |
| | | | | | fighting system. |
| 5) | Fire Engine | Yes | As there is no fire | No | As there is no fire |
| | exhaust line | | Engine in the | | Engine in the |
| | | | system | | system, |

| | | | |
|---|---|---|---|
| 1. | Increases the | 1. | Reduce the cost |
| | cost of | | of fire fighting |
| | firefighting | | system |
| | system | 2. | Reduces the risk |
| 2. | Increase the | | of fire hazard. |
| | risk of fire | | |
| | hazard. | | |

| | | | | | |
|---|---|---|---|---|---|
| 6) | Start up air | Yes | Since there is fire | No | Since there is no fire |
| | or gas storage | | Engine in the | | Engine in the |
| | vessel | | system, start-up | | system, start-up air |
| | | | air or gas vessel is | | or gas vessel not |
| | | | needed. | | needed |

| | | | |
|---|---|---|---|
| 1. | Occupy lot of | 1. | Doesn't occupy |
| | space on the | | any space on the |
| | platform. | | platform |
| 2. | Increases the | 2. | Reduce cost of |
| | cost of | | fire fighting |
| | firefighting | | system. |
| | system | 3. | Doesn't needs |
| 3. | Needs charging/ | | charging/filling |
| | filling of | | of air/gas |
| | air/gas | | mechanism. |
| | mechanism. | | |
| | Like start up air | | |
| | compressor/ | | |
| | gas pressure | | |
| | regulating | | |
| | mechanism. | | |

| | | | | | |
|---|---|---|---|---|---|
| 7) | Diesel storage | Yes | As fuel is used in | No | As fuel is not used |
| | vessel | | the system, | | in the system, |
| | | | storage vessel is | | storage vessel is not |
| | | | needed. | | needed. |

| | | | |
|---|---|---|---|
| 1. | Occupy lot of | 1. | Doesn't occupy |
| | space on the | | any space on the |
| | platform | | platform. |
| 2. | Increases the | 2. | It reduces the cost |
| | cost of | | of fire fighting |
| | firefighting | | system |
| | system | | |

| | | | | | |
|---|---|---|---|---|---|
| 8) | Fire water | Yes | As, main | No | As, main unit |
| | overboard | | assembly fire | | HPRTP assembly is |
| | line. | | engine is placed | | submerged in water, |
| | | | on platform, | | and water flow is |
| | | | water flow must | | regulated as per |
| | | | be regulated as | | requirement, as well |
| | | | per requirement, | | as, pressure relief is |
| | | | which need over | | inbuilt facility in |
| | | | board line. | | this invented unit, |

| | | | |
|---|---|---|---|
| 1. | Increase capital | 1. | It doesn't require |
| | cost due to | | over board line. |
| | expensive | 2. | Saves the material |
| | construction | | cost of Cu—Ni use |
| | material, Cu—Ni | | in over board line. |
| 2. | Needs pressure | 3. | Eliminates the |
| | relief valve to | | noise and |
| | regulate line | | vibration of |
| | pressure and | | platform |
| | safe guard the | | structure. |
| | system itself. | | |
| 3. | Noise and | | |
| | vibration is | | |
| | observed at | | |
| | overboard line. | | |

| | | | | | |
|---|---|---|---|---|---|
| 9) | Suction | Yes | Problem of | yes | Since, reverse flow |
| | Strainer. | | Marine Growth | | of water at higher |
| | | | which can | | pressure is possible |
| | | | stop/restrict flow | | in this system, |
| | | | of water | | marine growth can |
| | | | | | be removed easily |
| | | | | | any time. Only 5 |
| | | | | | minutes of regular |
| | | | | | reverse flow per |
| | | | | | month, is sufficient |
| | | | | | to prevent marine |
| | | | | | growth at suction |
| | | | | | strainer. |
| 10) | Diesel storage | Yes | Fire risk, as it is | No. | As fuel is not used |
| | tank. | | mounted on fire | | in the system, |
| | | | engine and there | | storage tank is not |
| | | | is limited area in | | needed. |
| | | | unmanned | | So, reduce the risk |
| | | | platform to locate | | of fire hazard on |
| | | | the engine. | | system itself. |
| 11) | Water | No | Not applicable. | Yes | Water injection |
| | injection | | | | header is main |
| | header | | | | source of energy for |
| | | | | | working of present |
| | | | | | invention. |
| | | | | | Utilization of stored |
| | | | | | energy in this |
| | | | | | header is most |
| | | | | | advantage of |
| | | | | | present invention. |
| 12) | Pressure | Yes | As fire engine | No | As header pressure |
| | Relief valve | | rotates with fixed | | is automatically |
| | | | RPM, needed to | | maintained in the |
| | | | maintain require | | system, there is no |
| | | | pressure in fire | | need of pressure |
| | | | water header. | | relief valve, |

| | | | |
|---|---|---|---|
| 1. | High noise | 1. | No noise |
| | pollution. | | pollution. |
| 2. | High vibration | 2. | No high |
| | of over board | | vibration. |
| | line | | |

| | | | | | |
|---|---|---|---|---|---|
| 13) | HPRTP | No | Not applicable | Yes | Since, Main |
| | | | | | component HPRTP |
| | | | | | (7 & 7A) is located |
| | | | | | at subsea level, |

| | |
|---|---|
| 1. | No noise |
| | pollution. |
| 2. | No ice formation. |
| 3. | No vibration. |
| 4. | No need of |
| | pressure relief |
| | valve. |
| 5. | No need of pump |
| | casing |
| 6. | No marine |
| | growth problem. |
| 7. | No lubricant |
| | requires. |
| 8. | No fuel |
| | consumption. |
| 9. | No frequent |
| | brake down of |
| | system. |
| 10. | Repair/ |
| | maintenance job |
| | is simple & easy. |

### Advantages of the Invention

1. Present automatic fire-fighting system for offshore platform that is efficient yet simple to install, energy saving, noise free, and economical.
2. Present automatic fire-fighting system for offshore platforms utilizes high pressure water from the water injection system at offshore platform which is already present at offshore oil and gas industries. This water provides the high pressure as energy source as well as water source. This eliminates the requirement of any additional system for providing pressure or energy. This also eliminates the requirement of fuel.
3. The pressure of water is used as source of energy while lifting additional water from the water body (sea; in case of oil and gas offshore platforms) to be sprinkled for fire-fighting. This enables the working of the system even in absence of fuel engine driven pump or electricity; unlike the prior arts. This makes the system energy efficient and economical. Besides, it is especially useful in cases of large fire of any type; when providing electricity for running water pumps is not feasible or advisable. It enhances its applicability at places where there is no electric connections or has limited electricity availability. So, there is no fuel consumption.
4. The mechanism of water lifting described in the present invention enables discharge of water with very high flow rate enabling water lifting to desired height for sprinkling it on fire. The discharged flow rate is in multiple of supplied flow rate. The present invented system (1) enables conversion of flow rate as well as achieving desired pressure for proper handling and requisite use; that can serve the purpose of present invention.
5. Present automatic firefighting system for offshore platforms that is self-cleaning and hence auto-maintenance.
6. Installation of present invented system (1) is possible by simple modification in existing offshore platform arrangement. This eliminates installation of additional multi-part arrangements thereby reduces the complexity in construction and operation. This also makes the present invention maintenance free. Moreover, it requires minimum space for installation.
7. Present invention; eliminates risk of fire on main component of firefighting system itself. This is because the main component i.e. the HPRTP (7)/HPRTP (7A) remains submerged in water.
8. No lubrication needed in Invented system. Thus, there is almost nil maintenance required for the system.
9. It ensures safeguard from fire; particularly to the unmanned platform and reduces the premium of insurance.
10. Present invented system (1) enables additional utility for using water for cleaning etc.
11. There is no noise pollution by the present invention unlike the prior arts.
12. Present invented system (1) is easy to operate and safe.
13. It is a system of lowest capital cost,
14. There is no operational cost in present invented system (1), as it does not use any fuel and it is automatic operation which does not require manpower to operate it.
15. Marine growth removal becomes easy by reversing secondary flow.
16. Over board line with pressure relief mechanism, constructed from high cost metal Cu—Ni (metal alloy, constructed by combination of copper and nickel) is not require in present invented System. It saves the cost.

Applicability of Present Invention:

The Submersible water lifting system and the automatic Fire Fighting System having the same assembly, has its main applicability in Oil and Gas Industry at offshore platforms particularly at unmanned platforms where electricity, fire engines and regular human presence are not available but high pressure water flow is available.

It can also be used at onshore to lift water for fire fighting, from low level ponds provided that high pressure water flow is available by any means like water injection lines, tanker having high pressure pump.

Though present invented system (1) is mainly designed for emergency fire fighting operations, it can also use as a utility or service water pump in all onshore and offshore installations where high pressure water flow is available. It can also be used in marine applications like stripping of blast tanks and sewage treatment plants etc. in ships.

There are varies applications of the present invented system (1); which includes, but not limited to the applications listed herein below. The system as a whole or part of system can also be used in below mentioned industries.
1. Pumping of slurries
2. Pumping fire water, where electrically driven pumps present an explosion risk
3. Draining and dewatering
4. Blending and proportioning
5. Flare gas recovery in Oil and Gas Industry.
6. Dozing of Chemicals, in process Industries.
7. Artificial lifting of Oil, in Oil and Gas Industry.
8. Deep water well pumping/domestic water supply.
9. For solid transfer.
10. As a vacuum pump.
11. As a thrust augmenters for dynamic positioning of ships.
12. It can be used to elevate low level water to medium level by utilising high elevated water.

1. A submersible water lifting assembly for automatic fire fighting system at unmanned platforms having said assembly wherein said fire-fighting system comprises:
Fire detection system (2),
Fire signal transmission line-1 (2a),
Water inlet line (3),
Control Panel (4),
Blow down Valve (5),
Instrument control line (5a),
Pressure Regulating Valve (6),
High Pressure Recovery Turbine Pump (7),
discharge water line (8),
fire water header (9),
Non Return Valve (9a),
Plurality of water sprinkler header (10),
First Water Sprinkler Header (10a),
Second Water sprinkler header (10b),
Fire Signal transmission line-2 (11),
Pressure taping (12),
Fire Water Header Isolation Valve (13),
Utility Water isolation Valve (14),
Utility water line (15),
Plurality of deluge valve (16),
Deluge valve-1 (16A),
Deluge valve-2 (16B),
Plurality of Sprinklers (18),
Water surface level (19),
Water body (20) (sea),
Supply pressure line (21),
Water injection header (22),
Plurality of water injection well (23);
Wherein:
the water inlet line (3) is connected with the water injection header (22) for operation of the present invented system (1), same way as plurality of water injection wells (23) is connected;
The fire signal transmission line-1 (2a) transmit the fire signal from the fire detection system (2) to the control panel (4) and further it transmits from the control panel (4) to a plurality of deluge valves (16) through fire signal transmission line-2 (11) to open deluge valve-1 (16A) or deluge valve-2 (16B) or both or more as per fire caught area;
Said Control panel (4) opens the blow down valve (5) provided in the water inlet line (3), through instrument control line (5a);
the water inlet line (3) is tapped from Water injection header (22) provides pressurized water to the present invented system (1);
The inflow of water from the water inlet line (3) is controlled by the pressure regulating valve (6) provided in said water inlet line (3), with the help of feedback pressure from the pressure taping (12), provided in the discharge water line (8);
Wherein:
Said submersible water lifting assembly is preferably a High Pressure Recovery Turbine Pump (HPRTP) (7) comprises:
Primary inlet (7a),
Secondary inlet (7b),
Discharge outlet (7c),
Suction Strainer (7d),
Turbine wheel housing (7e),
Partition wall (7f)
Central Hub Bushing or bearing (7g),
Turbine Runner (7h),
Runner bush washers-1 (7i),
Shaft key-1 (7j),
Turbine end bushing or bearing (7k),
Plurality of runner hole (7l),
Plurality of turbine bucket (7m),
plurality of housing hole (7n),
Impeller housing (7o),
Shaft-1 (7p),
Impeller (7q),
Impeller side bush washer (7r),
Impeller end bush washer (7s),
Oval shape aperture (7t),
Turbine wheel (7u),
Nozzle (7v),
Diffuser (7w),
Volute-1 (7x);
Wherein:
said HPRTP (7) is provided to receive high pressure water from the water inlet line (3) through its primary inlet (7a) to utilize the energy of said high pressure water and create the suction within the HPRTP (7) to suck more water from the water body (20) through its secondary inlet (7b);
a discharge outlet (7c) is provided to discharge water from the HPRTP (7);
a suction strainer (7d) provided on the secondary inlet (7b) to avoid the entry of marine substances into an impeller (7q),
a turbine wheel (7u), comprised of a turbine runner (7h) and a plurality of turbine bucket (7m);
wherein:
the plurality of turbine bucket (7m) comprises of two compartments: half cylindrical drum parted by both side tilted wall;
said turbine wheel (7u) is used as a prime mover; run by velocity of water jet through nozzle (7v) which is provided at the primary inlet (7a);
said turbine wheel (7u), is protected and supported by a turbine wheel housing (7e) and a partition wall (7f);
wherein:
said partition wall (70 supports a central hub bushing or bearing (7g), and separates the turbine wheel (7u) and the impeller (7q);
the turbine runner (7h) is fixed to a shaft-1 (7p) wherein:
one end of the shaft-1 (7p) is supported by a turbine end bushing or bearing (7k) which is fixed into the turbine wheel housing (7e); and
the central part of said shaft-1 (7p) is supported by the central hub bushing or bearing (7g) which is fixed in the partition wall (70;
an impeller end bush washer (7s) between an impeller housing (7o) and the impeller (7q) is provided to minimise water recycling from a pump volute-1 (7x) to the secondary inlet (7b) and also provides stability to the impeller (7q);
an oval shape aperture (7t) in the partition wall (7f), between the turbine wheel (7u) and the impeller (7q); forms volute-1 (7x); and allow water flow from the impeller (7q) and the turbine wheel (7u) to a diffuser (7w), through the volute-1 (7x);
the plurality of turbine bucket (7m) is fixed with the turbine runner (7h) by tightening bolts and nuts through a plurality of runner hole (7l);
said turbine wheel housing (7e), said partition wall (7f) and said impeller housing (7o) are boxed up by the help of bolts and nuts mounted within a plurality of housing hole (7n);
runner bush washers-1 (7i) are arranged on both the sides of turbine runner (7h), around the shaft-1 (7p);
an impeller side bush washer (7r) is provided to absorb axial thrust while of the turbine wheel (7u) rotates on shaft-1 (7p); and
the turbine wheel (7u) and the impeller (7q) are coaxially coupled together on the shaft-1 (7p) with the help of shaft key-1 (7j);
the turbine wheel housing (7e) is provided to protect turbine wheel (7u) from external water body (20) and support shaft-1 (7p); similarly, the impeller housing (7o) is provided to protect impeller (7q);
Said submersible water lifting system is provided to receive high pressure water from the water inlet line (3) through its primary inlet (7a) to utilize the energy of the same and create the suction within the HPRTP (7) to suck more water from the water body (20), through its secondary inlet (7b) and thereby reduces the pressure of the primary water and increase the amount of the water by sucking secondary water from water body (20); to be flown within the system; without use of any external source of energy; the primary water with reduced pressure and increased amount of discharged water from the HPRTP (7), to fire water header (9) through non return valve (9a), the discharge water line (8) and discharge outlet (7c); A suction strainer (7d) is provided on the secondary inlet (7b) to avoid the entry of marine substances; Discharge water line (8) allows the flow of the water, which is a mixture of initially received the water from water injection system and the water received from water body (20) (sea) from the HPRTP (7); A Plurality of water sprinkler headers (10) are provided to sprinkle water through a plurality of sprinklers (18); once it receives said mixture of water; amongst which, a first water sprinkler header (10a) is provided to sprinkle the water in upper deck and a second water sprinkler header (10b) is provided to sprinkle water in lower deck area;
a Non-Return Valve (9a) is provided in the system to facilitate single side flow of water for fire-fighting; a plurality of deluge valve (16) is provided for directing the water flow in area of fire;
the control panel (4) is alternatively powered by water pressure taken from water inlet line (3) through pressure supply line (21) or pneumatic/electric power depending on the location where system is used;
Said Utility Water isolation Valve (14) manually opens and fire water isolation valve (13) manually closes for directing the water flow to utility water header (15) for utility purposes like cleaning; and
A submersible water lifting system is placed under water body (20) below water surface level (19) for operational advantages and self protection from fire.

2. A submersible water lifting assembly for automatic fire fighting system at unmanned platforms having said assembly wherein said fire-fighting system comprises:
Fire detection system (2),
Fire signal transmission line-1 (2a),
Water inlet line (3),
Control Panel (4),
Blow down Valve (5),
Instrument control line (5a),
Pressure Regulating Valve (6),
Another embodiment HPRTP (7A),
discharge water line (8),
fire water header (9),
Non Return Valve (9a),
Plurality of water sprinkler header (10),
First Water Sprinkler Header (10a),
Second Water sprinkler header (10b),
Fire Signal transmission line-2 (11),
Pressure taping (12),
Fire Water Header Isolation Valve (13),
Utility Water isolation Valve (14),
Utility water line (15),
Plurality of deluge valve (16),
Deluge valve-1 (16A),
Deluge valve-2 (16B),
Plurality of Sprinklers (18),
Water surface level (19),
Water body (20) (sea),
Supply pressure line (21),
Water injection header (22),
Plurality of water injection well (23),
Wherein; the water inlet line (3) is connected with the water injection header (22) for operation of present invented system (1), same way as plurality of water injection wells (23) is connected; The fire signal transmission line-1 (2a) transmits the fire signal from fire detection system (2) to control panel (4) and the control panel (4) transmits it to plurality of deluge valve (16) through a fire signal transmission line-2 (11) to open deluge valve-1 (16A) or deluge valve-2 (16B) or both or more as per fire caught area;
Said Control panel (4) opens the blow down valve (5) provided in the water inlet line (3), through an instrument control line (5a);
The Water inlet line (3) tapped from the Water injection header (22) provides pressurized water to the present invented system (1); The inflow of water from the water inlet line (3) is controlled by the pressure regulating valve (6) provided in the water inlet line (3), with the help of feedback pressure received from pressure taping (12), wherein the pressure taping (12 is provided in discharge water line (8);
Wherein,
Said submersible water lifting assembly is preferably a High Pressure Recovery Turbine Pump (HPRTP) (7A) comprising:
Primary inlet (7a),
Secondary inlet (7b),
Discharge outlet (7c),
Suction Strainer (7d),
Turbine wheel housing (7e),
Stator wheel Bushing or bearing (7g′)
Turbine Runner (7h),
Runner bush washers-2 (7i′).
Shaft key-2 (7j′) for shaft fixing,
Turbine end bushing or bearing (7k),
Plurality of runner hole (7l),
plurality of turbine bucket (7m),
plurality of housing hole (7n),
Impeller housing (7o),
Shaft-2 (7p′),
Impeller (7q),
Impeller end bush washer (7s),
Turbine wheel (7u),
Nozzle (7v),
Diffuser (7w),
Volute-2 (7x′),
Stator wheel (7y),
Plurality of Propeller (7z),
Propeller housing (7zh);
Wherein said HPRTP (7A) is provided to receive high pressure water from the water inlet line (3) through its primary inlet (7a) to utilize the energy of the said high pressure water and create the suction within the HPRTP (7A) to suck more water from the water body (20) within which the present invented system (1) is used through its secondary inlet (7b);
a discharge outlet (7c) provided to discharge water from the HPRTP (7A);
a suction strainer (7d) provided on the secondary inlet (7b) to avoid the entry of marine substances into impeller (7q);
a turbine wheel (7u), comprised of a turbine runner (7h) and a plurality of turbine buckets (7m), wherein
a plurality of turbine bucket (7m) comprises of two compartments: half cylindrical drums parted by both side tilted wall; wherein
said turbine wheel (7u) is used as a prime mover; run by velocity of water jet through a nozzle (7v) which is provided at the primary inlet (7a);
Said turbine wheel (7u) is protected and supported by a turbine wheel housing (7e); a turbine runner (7h) is fixed with shaft-2 (7p′);
one end of shaft-2 (7p′) is supported by turbine end bushing or bearing (7k) which is fixed into turbine wheel housing (7e); and other end of said shaft-2 (7p′) is supported by stator wheel bushing or bearing (7g′) which is fixed in the stator wheel (7y) provided at the suction end of impeller housing (7o);
An impeller end bush washer (7s), between an impeller housing (7o) and the impeller (7q), is provided to minimize water recycling forms pump volute-2 (7x′) to the secondary inlet (7b) and also provides stability to the impeller (7q);
said turbine wheel (7u) and the impeller (7q) enclosed by impeller housing (7o) and turbine housing (7e); forms a volute-2 (7x′); and allows water flow from the impeller (7q) and the turbine wheel (7u) to the diffuser (7w), through volute-2 (7x′);
a plurality of turbine buckets (7m) is fixed with the turbine runner (7h) by tightening bolts and nuts through a plurality of runner hole (7l);
The said turbine wheel housing (7e) and the impeller housing (7o) are boxed up together with the help of bolts and nuts through plurality of housing hole (7n);
the runner bush washer-2 (7i′) on one side of the turbine runner (7h), around the shaft-2 (7p′) is provided to absorb axial thrust while the turbine wheel (7u) rotates on shaft-2 (7p′);
said turbine wheel (7u) and the impeller (7q) are coupled together in a shaft-2 (7p′) with the help of shaft key-2 (7j′);
said plurality of propeller (7z) is enclosed by a propeller housing (7zh); whereas stator wheel (7y) and impeller (7q) are enclosed by impeller housing (7o); wherein the turbine wheel (7u), the impeller (7q) and s plurality of propeller (7z) are coaxially fixed with shaft-2 (7p′);
the turbine wheel housing (7e) is provided to protect turbine wheel (7u) from external water body (20) and support shaft-2 (7p′); similarly, the impeller housing (7o) is provided to protect the impeller (7q) and a support shaft-2 (7p′) through a stator wheel (7y) at the other end with the help of a stator wheel bushing or bearing (7g′); said plurality of propeller (7z) is provided to boost up the water flow into the impeller (7q), to raise the suction pressure of water flow; wherein the impeller (7q) alone functions as a single stage centrifugal pump whereas along with plurality of propellers (7z) it functions as a multistage centrifugal pump; thereby said HPRTP (7A) functions as a multi stage centrifugal pump wherein the stator wheel bushing or bearing (7g′) and the turbine end bushing or bearing (7k) are provided for the smooth rotation of shaft-2 (7p′) along with the rotation of turbine wheel (7u), the impeller (7q) and a plurality of propeller (7z); the stator wheel (7y), provides support to shaft-2 (7p′) through the stator wheel bushing or bearing (7g′) and the impeller housing (7o);
A submersible water lifting system is provided to receive high pressure water from the water inlet line (3) through its primary inlet (7a) to utilize the energy of the same and create the suction within the HPRTP (7A) to suck more water from the water body (20), through its secondary inlet (7b) and thereby reduces the pressure of the primary water and increases the amount of the water by sucking secondary water from water body (20) to be flown within the system without use of any external source of energy; the primary water with reduced pressure and increased amount of discharged water from HPRTP (7A), to the fire water header (9) through a non-return valve (9a), a discharge water line (8) and a discharge outlet (7c);
Said Plurality of water sprinkler headers (10) are provided to sprinkle water through a plurality of sprinklers (18); once it receives said mixture of water; amongst which, a first water sprinkler header (10a) is provided to sprinkle water in the upper deck and a second water sprinkler header (10b) is provided to sprinkle water in the lower deck area; a Non-Return Valve (9a) is provided in the system to facilitate single side flow of water for fire-fighting; a plurality of deluge valves (16) are provided for directing the water flow in area of fire;
the control panel (4) is alternatively powered by water pressure taken from water inlet line (3) through pressure supply line (21) or pneumatic/electric power depending on the location where system is used;
Said Utility Water isolation Valve (14) manually opens and fire water isolation valve (13) manually closes for directing the water flow to utility water header (15) for utility purposes like cleaning; and
A submersible water lifting system is placed under water body (20) below water surface level (19) for operational advantages and self protection from fire.

3. An automatic fire fighting system for unmanned platforms having submersible water lifting assembly according to claims 1 wherein:
closing Fire Water Header Isolation Valve and Utility Water isolation Valve allows water to be directed towards said secondary inlet for automatic cleaning of said suction strainer.

4. An automatic fire fighting system for unmanned platforms having submersible water lifting assembly according to claim 2 wherein:
closing Fire Water Header Isolation Valve and Utility Water isolation Valve allows water to be directed towards said secondary inlet for automatic cleaning of said suction strainer.
